(19) United States
(12) Patent Application Publication
(10) Pub. No.: US 2014/0055280 A1
(43) Pub. Date: Feb. 27, 2014

(54) WIRELESS COMMUNICATION MONITORING DEVICE, WIRELESS COMMUNICATION MONITORING SYSTEM, WIRELESS COMMUNICATION MONITORING METHOD, AND NON-TRANSITORY COMPUTER-READABLE RECORDING MEDIUM

(71) Applicants: Noamasa Iwahashi, Kyoto (JP); Takashi Nishimura, Kyoto (JP)

(72) Inventors: Noamasa Iwahashi, Kyoto (JP); Takashi Nishimura, Kyoto (JP)

(73) Assignee: OMRON CORPORATION, Kyoto (JP)

(21) Appl. No.: 14/001,976

(22) PCT Filed: Mar. 17, 2011
(86) PCT No.: PCT/JP2011/056446

§ 371 Date: Nov. 12, 2013

(30) Foreign Application Priority Data
Mar. 15, 2011 (JP) 2011 057279

(51) Int. Cl. G08C 17/02

(52) U.S. Cl. CPC G08C 17/02
USPC 340/870.01

(57) ABSTRACT

A wireless communication monitoring device includes: a communication unit receiving wireless signals from a detecting and transmitting device; a signal intensity detecting unit detecting reception intensities of the wireless signals sequentially received by the communication unit; a signal intensity storing unit comparing each of the reception intensities detected by the signal intensity detecting unit with a predetermined minimum reception intensity to obtain a communication margin, and sequentially storing the obtained communication margins into a storing device; a signal intensity computing unit obtaining an average value and a variation of communication margins stored in the storing device and computing a ratio of the average value to the variation of communication margins as a computation value for determination; and a determining unit determining whether a reception state of the wireless signal in the communication unit is an unstable communication state or a stable communication state.

### CROSS-REFERENCE TO RELATED APPLICATION(S)

This application claims the benefit of priority from Japanese Patent Application No. 2011-057279, filed 15 Mar. 2011, and International Application No. PCT/JP2011/056446, filed 17 Mar. 2011 and designating the United States, the entire contents of which is incorporated herein by reference for all purposes.

### BACKGROUND

The present invention relates to a communication control unit and a communication control method for use in wireless communication.

In recent years, in communication with a wireless device, the presence of buildings and people around the wireless device often disturbs the communication. To obtain excellent communication environment, the signal intensity and the success rate of communication in the case of receiving data by a wireless device are monitored. In the case where a predetermined condition is not satisfied, a setting of the communication is changed.

For example, Japanese Unexamined Patent Publication No. 2002-374560 (disclosed on Dec. 26, 2002) (Patent Document 1) discloses a technique, in packet communication between a mobile station and a base station, of measuring an error rate in the case where the mobile station receives packet data and, when the error rate becomes equal to or larger than a threshold value, changing a channel for use in communication.

Japanese Unexamined Patent Publication No. 08-65223 (disclosed on Mar. 8, 1996) (Patent Document 2) discloses a technique that, in data communication using a wireless LAN or the like, a receiver has a plurality of antennas, occurrence frequency of an error in data received by the receiver is monitored, and an antenna whose reception wave intensity is determined as maximum is selected from antennas whose error occurrence frequency is determined as a predetermined value or less.

However, the above-described conventional techniques have a problem that a dropout of data in communication cannot be prevented.

Specifically, in the technique disclosed in Patent Document 1, a channel for use in communication is changed when the error rate in the case of receiving data by a mobile station becomes equal to or larger than a threshold value. Consequently, a handling is made after a dropout actually occurs in reception data. Therefore, a dropout of data in communication cannot be prevented.

In the technique disclosed in Patent Document 2, an antenna used is switched to an antenna having the maximum reception radio field intensity among antennas whose error occurrence frequency received by the receiver is predetermined value or less. Consequently, a handling is made after a dropout actually occurs in reception data. Therefore, similarly, a dropout of data in communication cannot be prevented.

Even when the signal intensity is weak, when a path of the wireless signal is predetermined, communication does not fail. Consequently, even in a position where the signal intensity is weak, a wireless device must be originally installable. However, when such an installation position is eliminated because the signal intensity is weak, a problem occurs such that a wireless device cannot be installed even in an originally installable place. At the time of installing the wireless device, even if the signal intensity is sufficient in a check or test at the time of installation in the communication environment of the wireless device, the signal intensity changes due to a subsequent layout change or the like in the installation place. Consequently, there is the possibility of occurrence of a trouble that communication cannot be performed in actual operation of the wireless device. The above-described conventional techniques cannot properly deal with such a problem.

Therefore there is a need to provide a wireless communication monitoring device, a wireless communication monitoring system, a wireless communication monitoring method, a program, and a recording medium that can prevent a dropout of data in communication.

### SUMMARY

Disclosed is a wireless communication monitoring device comprising: a receiving unit configured to receive wireless signals from a detecting and transmitting device performing measurement by a sensor and to sequentially transmit obtained measurement data as wireless signals; a signal intensity detecting unit configured to detect reception intensities of the wireless signals sequentially received by the receiving unit; a signal intensity storing unit configured to compare each the reception intensities detected by the signal intensity detecting unit with a predetermined minimum reception intensity to obtain a communication margin indicative of a margin of each reception intensity with respect to the minimum reception intensity, and to sequentially store the obtained communication margins into a storing device; a signal intensity computing unit configured to obtain an average value and a variation of communication margins stored in the storing device and to compute a ratio of the average value to the variation of communication margins as a computation value for determination; and a determining unit configured to determine whether a reception state of the wireless signal in the receiving unit is an unstable communication state or a stable communication state by comparing the computation value for determination with a predetermined threshold value.

### BRIEF DESCRIPTION OF THE DRAWINGS

FIG. 1 is a block diagram illustrating a configuration of an air-conditioning control system having a wireless communication monitoring system of an embodiment.

FIG. 2 is a block diagram illustrating a configuration of a wireless communication monitoring device illustrated in FIG. 1.

FIG. 3 is a block diagram illustrating a configuration of a wireless communication monitoring system configured to obtain a threshold value to be set in a setting unit illustrated in FIG. 2.

FIG. 4 is an explanatory diagram illustrating an average value of communication margins, a variation σ of the communication margins, a ratio (average value/σ) of the average value to the variation of the communication margins, and the communication success rate, obtained by a verification experiment in the wireless communication monitoring system illustrated in FIG. 4.

FIG. 5 is a graph illustrating the relationship between the communication success rate and the ratio (average value/σ) of the average value to the variation of communication margins, obtained from the measurement results illustrated in FIG. 4.

FIG. 6 is an explanatory diagram illustrating an example of elements (communication environments) exerting influence on average communication intensity and a variation in communication intensity in communication between general wireless devices.

FIG. 7 is an explanatory diagram illustrating an example of setting a threshold value according to time slots in the setting unit illustrated in FIG. 2 in the case where a change in the communication environment between a temperature detecting and transmitting device and a wireless communication monitoring device shown in FIG. 1 occurs depending on the degree of intervention of people.

FIG. 8 is an explanatory diagram illustrating the flow of data in the wireless communication monitoring system of the embodiment.

FIG. 9 is a flowchart illustrating operations of the wireless communication monitoring device illustrated in FIG. 2.

FIG. 10 is a schematic diagram illustrating a layout example of temperature detecting and transmitting devices and a wireless communication monitoring device in a building, in the air-conditioning control system shown in FIG. 1.

FIG. 11 is a schematic diagram illustrating a structure of a room illustrated in FIG. 10 in which the temperature detecting and transmitting device is disposed.

FIG. 12 is a schematic diagram illustrating a state in which the layout position of the temperature detecting and transmitting device is changed according to an alarm output from an alarm output unit in the room shown in FIG. 11.

### DESCRIPTION

At least an embodiment of the present invention will be described below with reference to the drawings.

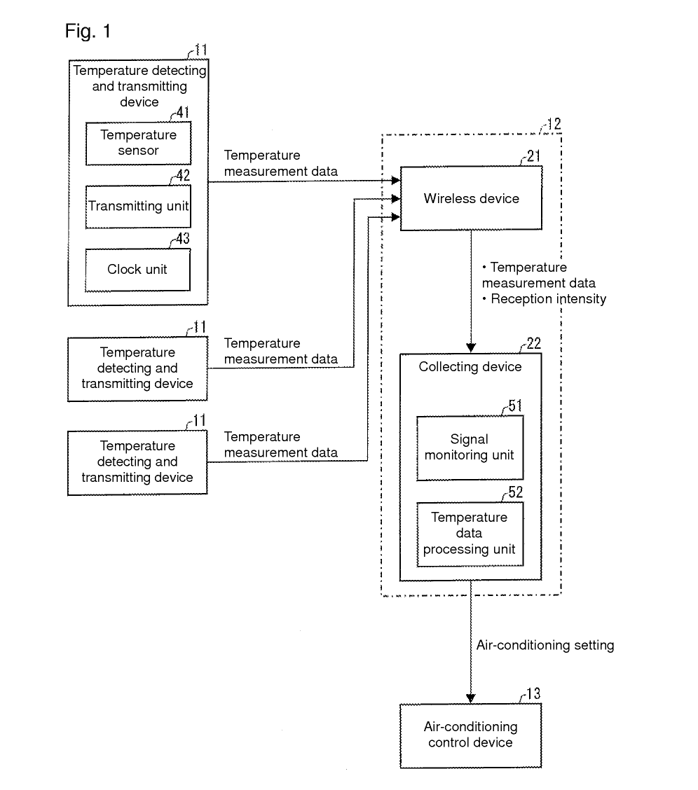

FIG. 1 is a block diagram illustrating a configuration of an air-conditioning control system having a wireless communication monitoring system of an embodiment.

As illustrated in FIG. 1, an air-conditioning control system 1 has a plurality of temperature detecting and transmitting devices (a detecting and transmitting device or a transmitting device) 11, a wireless communication monitoring device 12, and an air-conditioning control device 13. The plurality of temperature detecting and transmitting devices 11 and the wireless communication monitoring device 12 configure a wireless communication monitoring system.

Each of the temperature detecting and transmitting devices 11 has a temperature sensor 41, a transmitting unit 42, and a clock unit 43 and is disposed for a temperature measurement target, for example, a wall of a room, a manufacture facility, or the like. Although the configuration of only one temperature detecting and transmitting device 11 is specifically illustrated in FIG. 1, the other temperature detecting and transmitting devices 11 have the same configuration.

In the temperature detecting and transmitting device 11, the temperature sensor 41 measures temperature of a temperature measurement target every predetermined time. The transmitting unit 42 transmits a radio signal of temperature measurement data indicative of the temperature measured by the temperature sensor 41 to the wireless communication monitoring device 12.

Concretely, the transmitting unit 42 transmits, as temperature measurement data, the temperature detected by the temperature sensor 41, for example, every minute. In this case, to the temperature measurement data transmitted, a temperature sensor ID for identifying the temperature sensor 41 and temperature measurement time are added.

The wireless communication monitoring device 12 has a wireless device 21 and a collecting device 22. The wireless device 21 receives a wireless signal of the temperature measurement data every predetermined time transmitted from the temperature detecting and transmitting device 11 and measures signal intensity, that is, reception intensity of the wireless signal of the temperature measurement data. Further, the wireless device 21 adds information indicative of reception intensity to the received temperature measurement data and outputs the resultant data to the collecting device 22.

The collecting device 22 has a signal monitoring unit 51 and a temperature measurement data processing unit 52. The signal monitoring unit 51 monitors information indicative of reception intensity of the temperature measurement data received from the wireless device 21 and, in the case where an alarm to the user is necessary from the monitoring result, outputs an alarm. The temperature measurement data processing unit 52 generates air-conditioning setting data used by the air-conditioning control device 13 from the temperature measurement data received from the wireless device 21 and outputs the resultant data to the air-conditioning control device 13.

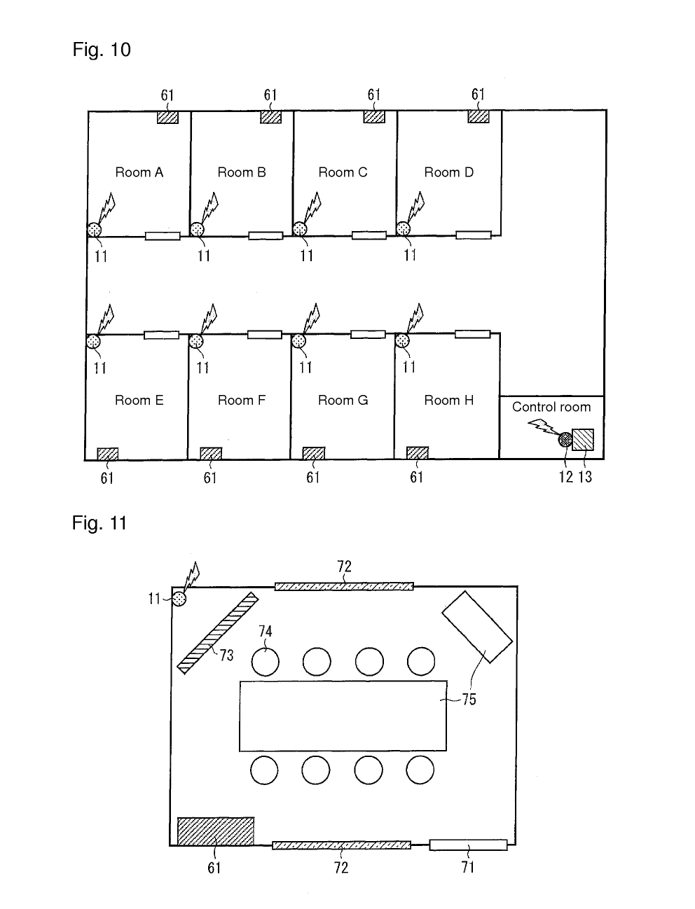

The air-conditioning control device 13 controls the operation of an air-conditioning device 61 (see FIG. 10) based on the air-conditioning setting data received from the collecting device 22. The air-conditioning device 61 adjusts the temperature of a room, a manufacture facility, or the like as a temperature measurement target measured by the temperature detecting and transmitting device 11.

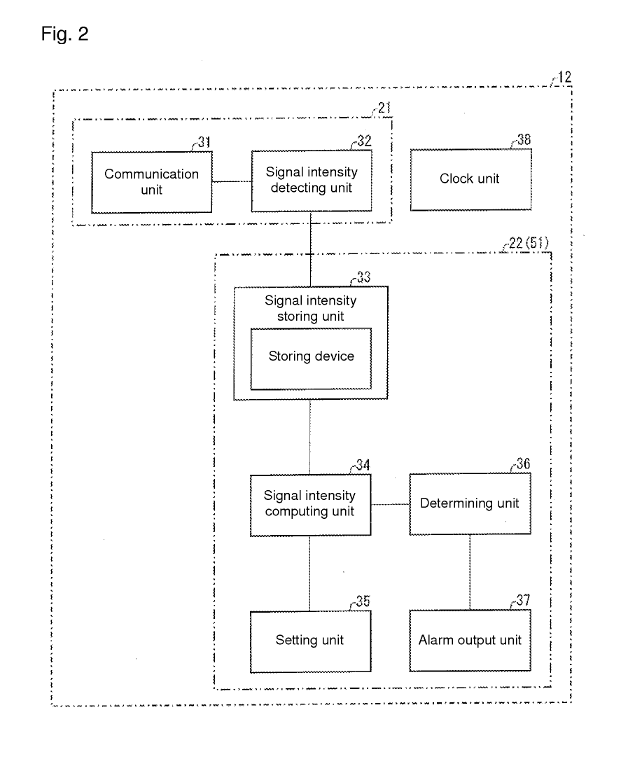

Next, the configuration of the wireless communication monitoring device 12 will be described in detail. FIG. 2 is a block diagram illustrating a configuration of the wireless communication monitoring device 12 shown in FIG. 1. In FIG. 2, only the configuration of the signal monitoring unit 51 in the collecting device 22 is illustrated.

As illustrated in FIG. 2, the wireless communication monitoring device 12 has, specifically, the wireless device 21, the collecting device 22, and a clock unit 38. The wireless device 21 has a communication unit (reception unit) 31 and a signal intensity detecting unit 32. The collecting device 22 has a signal intensity storing unit 33, a signal intensity computing unit 34, a setting unit 35, a determining unit 36, and an alarm output unit 37.

The communication unit 31 receives the wireless signal of the temperature measurement data every predetermined time transmitted from the temperature detecting and transmitting devices 11. The signal intensity detecting unit 32 detects reception intensity of the wireless signal of the temperature measurement data from each of the temperature detecting and transmitting devices 11 received by the communication unit 31, adds information indicative of the detected reception intensity to the temperature measurement data, and outputs the resultant data to the signal intensity storing unit 33. The signal intensity detecting unit 32 may detect reception intensity from, for example, the amplitude of the wireless signal, and the detected reception intensity may be included in the temperature measurement data or added to the temperature measurement data.

The signal intensity storing unit 33 has a storing device and stores the temperature measurement data and the measurement time supplied from the signal intensity detecting unit 32 for each of the temperature detecting and transmitting devices 11. The signal intensity storing unit 33 also obtains the difference between the reception intensity of each of the temperature measurement data and the lowest reception intensity of the wireless communication monitoring device 12 and stores, as communication margin, the obtained difference together with the measurement time of the temperature measurement data into the storing device for each of the temperature detecting and transmitting devices 11. The lowest reception intensity is set as a minimum reception intensity for the wireless communication monitoring device 12 in the specifications of the wireless communication monitoring device 12. The communication margin is not limited to the difference of the reception intensity from the minimum reception intensity but may be the ratio of the reception intensity to the minimum reception intensity.

The signal intensity computing unit 34 obtains, for each of the temperature detecting and transmitting devices 11, the average value of predetermined number of communication margins stored in the signal intensity storing unit 33 or communication margins in a predetermined period (predetermined time) and the variation σ of the communication margins and further, as a computation value for determination, an average value ratio with respect to the variation σ. The period or the like of obtaining the average value of the communication margins and the variation σ of the communication margins is set in the setting unit 35 and the computation is performed in the period or the like.

Concretely, for each of the temperature detecting and transmitting devices 11, for example, each time the communication margin is calculated in the signal intensity storing unit 33, the signal intensity computing unit 34 calculates the average value of the communication margins in past two hours and the variation a of the communication margins in the same past two hours and further, calculates the average value/σ as the computation value for determination.

In the setting unit 35, various settings can be made by a user input and a threshold value for determining the propriety of the computation value for determination in the determining unit 36 is set. In the signal intensity computing unit 34, a period or the like of obtaining the average value of communication margins and the variation σ of the communication margins is set. Further, in the case where whether an alarm output in the alarm output unit 37 is necessary or not is set, the alarm output is set as “necessary”, and a plurality of kinds of alarms can be output from the alarm output unit 37, the kind or the like is set.

The determining unit 36 compares the computation value for determination for each of the temperature detecting and transmitting devices 11 calculated by the signal intensity computing unit 34 with the threshold value set in the setting unit 35 and determines the propriety of the computation value for determination. Concretely, in the case where the computation value for determination is smaller than the threshold value, communication between the temperature detecting and transmitting device 11 and the wireless communication monitoring device 12 is determined as an unstable communication state. In the case where the unstable communication state is determined in the determining unit 36, the possibility of occurrence of a dropout of reception data in reception of the wireless signal from the detecting and transmitting device can be predicted. In this case, the user changes the layout position of the detecting and transmitting device based on the determination of the unstable communication state in the determining unit 36 to set the reception state of the wireless signal from the detecting and transmitting device to the stable communication state, thereby enabling occurrence of a dropout of reception data to be prevented. In the case where the computation value for determination is equal to or larger than the threshold value, communication between the temperature detecting and transmitting device 11 and the wireless communication monitoring device 12 is determined as a stable communication state.

In the case where the communication between the temperature detecting and transmitting device 11 and the wireless communication monitoring device 12 is determined as an unstable communication state in the determining unit 36, the alarm output unit 37 outputs an alarm to urge the user to change the position of the corresponding temperature detecting and transmitting device 11. The alarm output is an alarm from a buzzer or a speaker, turn-on of a lamp such as an LED lamp, an alarm displayed on a screen in a display device, notification of an alarm by an e-mail, or the like. With respect to the alarm output in the alarm output unit 37, in the case where whether the alarm output is necessary or not can be set and a plurality of alarm outputs are possible by a user setting in the setting unit 35, the kind of the alarm can be set. With the configuration, in the case where the determining unit determines that the reception state of the wireless signal from the detecting and transmitting device is an unstable communication state, an alarm is output from the alarm output unit. The user can clearly know from the alarm output that the reception state from the detecting and transmitting device is the unstable communication state. Therefore, the user changes the layout position of the detecting and transmitting device to set the reception state of the wireless signal from the detecting and transmitting device to the stable communication state, thereby enabling occurrence of a dropout of reception data to be prevented.

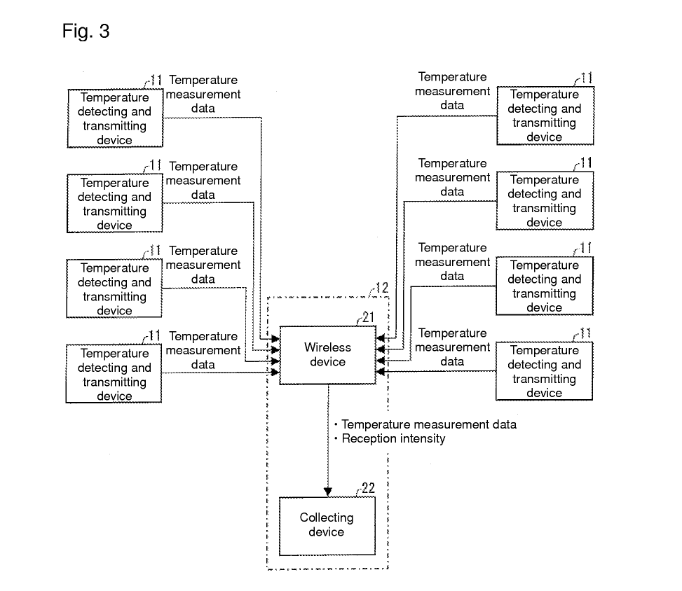

Next, a method of setting a threshold value which is set in the setting unit 35 will be described. In the embodiment, a threshold value is obtained by an actual verification experiment and set. To obtain a threshold value, a verification experiment was conducted by the configuration of the wireless communication monitoring system illustrated in FIG. 3. FIG. 3 is a block diagram illustrating the configuration of the wireless communication monitoring system configured to obtain a threshold value to be set in the setting unit 35.

In the verification experiment, eight temperature detecting and transmitting devices 11 were installed in an office floor. Communication was performed for 20 minutes in the time slot of 00:00 to 06:59 from the temperature detecting and transmitting devices 11 to the wireless device 21 of the wireless communication monitoring device 12. With respect to each of the temperature detecting and transmitting devices 11 in the installation positions, the average value of communication margins, a variation σ of the communication margins, the ratio (average value/σ) of the average value to the variation of communication margins, and the communication success rate were measured and the relationships of them were obtained. The number of patterns of installation of the eight temperature detecting and transmitting devices 11 was set to eight, and the total number of the temperature detecting and transmitting devices 11 was set to 64.

The operation of the wireless communication monitoring system in this case is as follows. The temperature detecting and transmitting device 11 transmits the temperature measurement data every 10 seconds to the wireless device 21 of the wireless communication monitoring device 12. The wireless device 21 transmits the temperature measurement data received from the temperature detecting and transmitting device 11 and its reception intensity to the collecting device 22. The collecting device 22 collects the temperature measurement data.

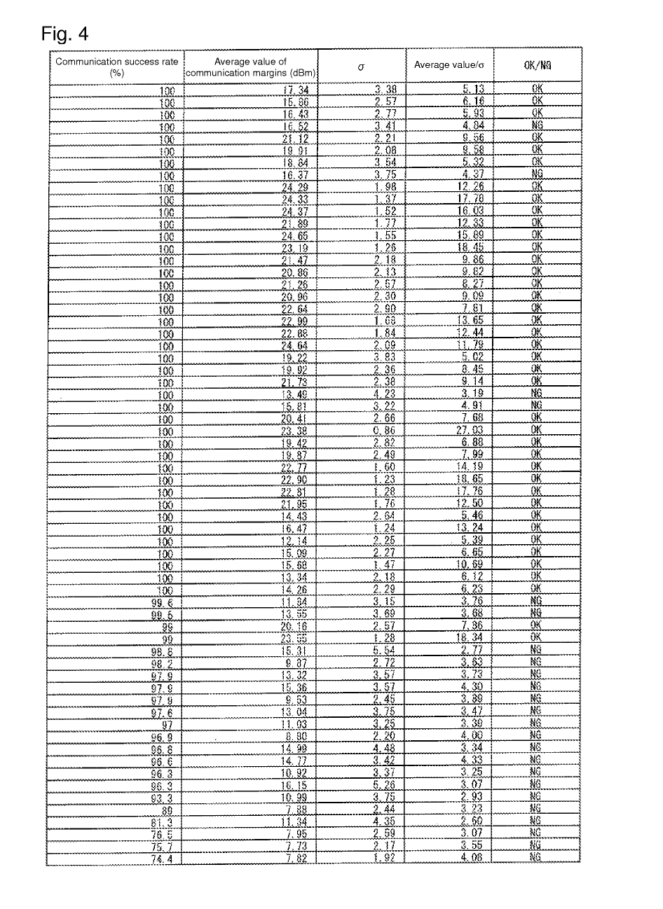

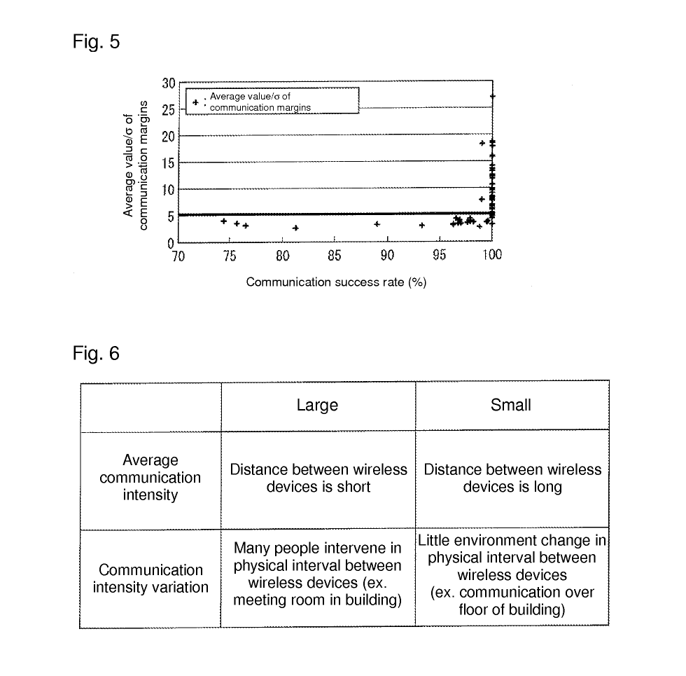

The result of the experiment using the total 64 temperature detecting and transmitting devices 11 is illustrated in FIG. 4. FIG. 4 illustrates an average value of communication margins, variation σ of the communication margins, the ratio (average value/σ) of the average value to the variation of communication margins, and the communication success rate for a measurement result of each of the total 64 temperature detecting and transmitting devices 11. The graph of FIG. 5 illustrates the relationship between the communication success rate and the ratio (average value/σ) of the average value to the variation of communication margins obtained from the measurement results illustrated in FIG. 4.

As understood from FIGS. 5 and 4, the communication success rate is dispersed in the range of 74.4% to 100% when the ratio of the average value to the variation of communication margins is less than five, and is 99% or higher (99% to 100%) when the ratio of the average value to the variation of communication margins is five or larger. That is, in the case where the ratio of the average value to the variation of communication margins is less than five, even when the communication success rate is 100% in the experiment result, it can be determined that the possibility that the communication success rate decreases in communication for a long period is high. In the above case, therefore, preferably, the threshold value to be set by the setting unit is set to five. In this case, in the determining unit 36, if the communication value for determination (average value/σ) is less than five, an unstable communication state is determined. When the computation value for determination (average value/σ) is five or larger, it is determined as a stable communication state. Based on the above configuration, a proper threshold value can be set as the threshold value for determining the stable communication state and the unstable communication state in reception of the wireless signal from the detecting and transmitting device in the determining unit, and excellent determination is possible in the determining unit.

In the case where the communication success rate is 99% when the threshold value is set to five, data of the remaining one percent which fails in communication can be collected by a retry process of communication.

Next, the operation of setting a threshold value according to a time slot in the setting unit 35 will be described.

A wireless communication environment between the temperature detecting and transmitting device 11 and the wireless communication monitoring device 12 changes according to movement of a people or a change in the layout of objects between the temperature detecting and transmitting device 11 and the wireless communication monitoring device 12. Particularly, in the case where the wireless communication monitoring system is installed in a building, basically, there is a tendency that variations in the communication intensity become large in a time slot in which a human intervenes, and variations in the communication intensity become small in a time slot in which a human does not intervene. The intervention of a human among elements exerting influence on the communication environments is an element which cannot be eliminated in the environments in which the wireless communication monitoring system is installed.

In such communication environments, in the case of setting the same threshold value as that set in a first time slot in which a human hardly intervenes such as after-office hours of a company in a second time slot in which humans easily intervene such as office hours of a company, the possibility that an alarm is output frequently from the alarm output unit 37 in the second time slot is high.

In such a case, to prevent a situation that an alarm is output frequently from the alarm output unit 37 in the second time slot, preferably, the setting unit 35 changes the threshold value between the first and second time slots. The threshold value in each time slot can be obtained similarly by performing the verification experiment described with reference to FIGS. 3 to 5 by time slots.

FIG. 6 illustrates an example of elements (communication environments) exerting influence on average communication intensity and variation in communication intensity, in communication between general wireless devices. As illustrated in FIG. 6, the average communication intensity is large in the case where the distance between wireless devices is short, and is small in the case where the distance between wireless devices is long. The variation in communication intensity is large in the case where a human intervenes in a physical interval between wireless devices, and is small in the case where the environment change in the physical interval between wireless devices is small. The average communication intensity and the variation in communication intensity can be regarded as an average value of communication margins and variation in communication margins, respectively, in accordance with the embodiment.

Combinations of the case where the average value of communication margins is large (high), the case where it is small (low), the case where the variation in communication margins is large, and the case where it is small are four ways (1) to (4) as will be described below. The descending order of severity of the unstable state in the case where the communication between the temperature detecting and transmitting device 11 and the wireless communication monitoring device 12 is determined as an unstable state by the determining unit 36 is (1), (2), (3), and (4). Therefore, in the case where it is determined by the determining unit 36 that the communication between the wireless communication monitoring device 12 and the plurality of temperature detecting and transmitting devices 11 is in the unstable state, the priority to be adopted in each of the temperature detecting and transmitting devices 11 is the order of (1), (2), (3), and (4).

(1) A case where the average value of communication margins is low and variation in the communication margins is large: a state where the possibility of dropout of temperature measurement data is highest. A state where the physical distance between the temperature detecting and transmitting device 11 and the wireless communication monitoring device 12 is long and a mobile object which causes a change in the communication environment frequently moves between the temperature detecting and transmitting device 11 and the wireless communication monitoring device 12.

(2) A case where the average value of communication margins is high and variation in the communication margins is large: a state where the possibility of dropout of temperature measurement data is the second highest. A state where although the physical distance between the temperature detecting and transmitting device 11 and the wireless communication monitoring device 12 is short, a mobile object which causes a change in the communication environment frequency moves between the temperature detecting and transmitting device 11 and the wireless communication monitoring device 12.

(3) A case where the average value of communication margins is low and variation in communication margins is small: a state where the possibility of dropout of temperature measurement data is the third highest. A state where although the physical distance between the temperature detecting and transmitting device 11 and the wireless communication monitoring device 12 is long, a communication state is stable. However, if a change occurs in the communication environment in future, there is the possibility that a variation in the communication margins becomes large.

(4) A case where the average value of communication margins is large and variation in communication margins is small: a state where the possibility of dropout of temperature measurement data is low.

On the other hand, even in the first time slot in which people hardly intervenes, there is a case that the variation in communication intensity changes. This is, for example, a case such that when the temperature detecting and transmitting device 11 and the wireless communication monitoring device 12 are installed near the window of a building, radio waves from the temperature detecting and transmitting device 11 do not directly reach the wireless communication monitoring device 12 in the building but reaches the wireless communication monitoring device 12 by reflection from the outside of the building. In such a case, although the variation in the communication intensity is smaller than that in the second time slot in which people intervenes, for example, by a change in the communication environment around the building, such as a change in the passage amount of vehicles, a variation in the communication intensity occurs.

Preferably, the threshold value set in the setting unit 35 is changed according to the time slot, concretely, according to a change in the communication environment which changes with time. In this case, the communication environment varies depending on a facility or place in which the temperature detecting and transmitting device 11 and the wireless communication monitoring device 12 in the wireless communication monitoring system are installed. Therefore, the time slot in which the communication environment changes, the signal intensity in each time slot, and the direction of the change in the variation of the signal intensity also vary. Therefore, the threshold value according to the time slot in the setting unit 35 can be arbitrary set by the user. With the configuration, an unavoidable change in the communication environment according to a time slot between the detecting and transmitting device and the wireless communication monitoring device can be properly handled, and a situation that the unstable communication state is determined frequency in the determining unit can be prevented.

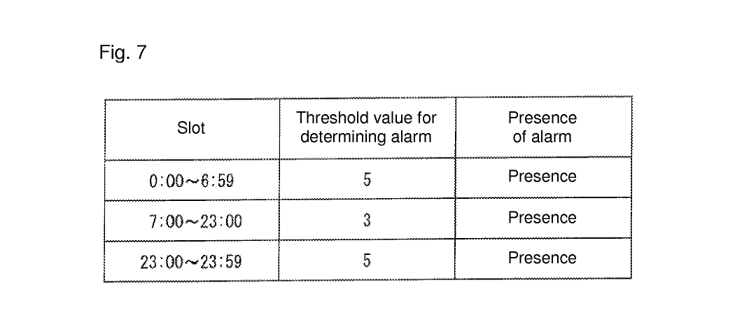

FIG. 7 illustrates an example of setting a threshold value according to time slots in the setting unit 35 in the case where a change in the communication environment between the temperature detecting and transmitting device 11 and the wireless communication monitoring device 12 occurs depending on the degree of intervention of people. In the example of FIG. 7, the threshold value of the time slot from 7:00 to 23:00 in which the intervention of people is relatively large is set to be smaller than threshold values in the other time slots. Consequently, in the time slot from 7:00 to 23:00 in which the intervention of people is relatively large, a situation can be prevented that an alarm is output frequently from the alarm output unit 37 in the wireless communication monitoring device 12 due to deterioration in the communication environment between the temperature detecting and transmitting device 11 and the wireless communication monitoring device 12 caused by intervention of people.

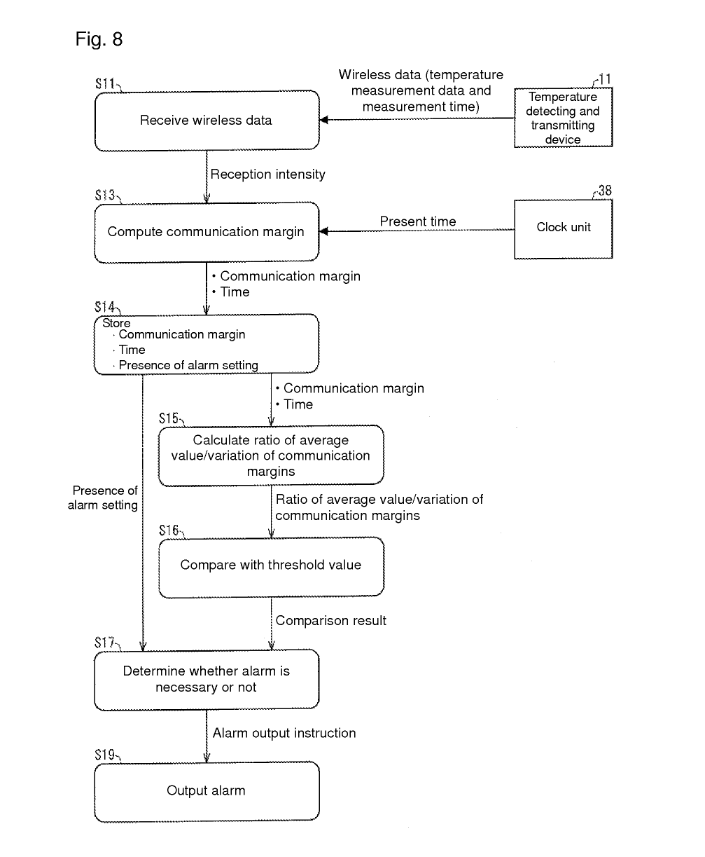

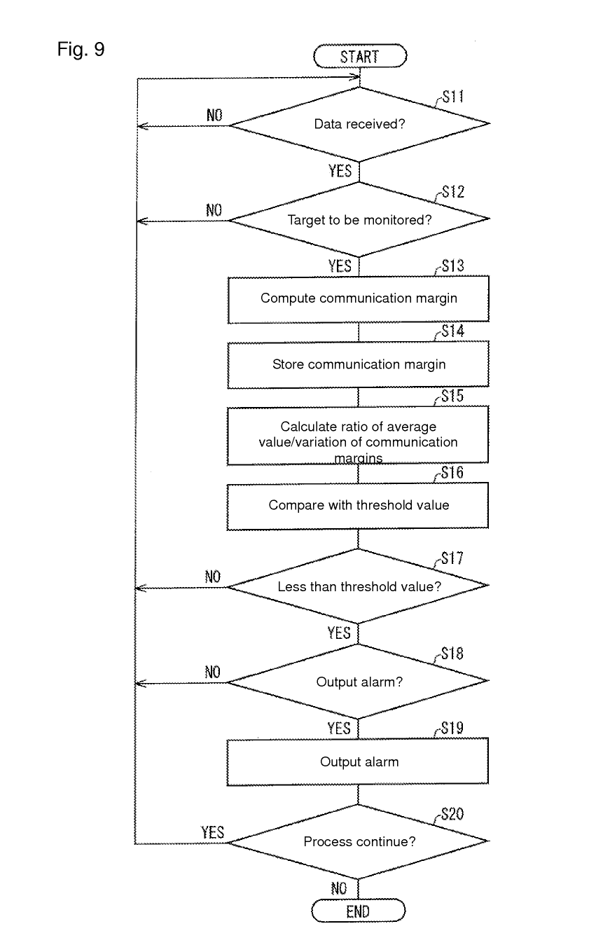

In the configuration, the operation of the wireless communication monitoring system of the embodiment will be described below with reference to FIGS. 8 and 9.

FIG. 8 is an explanatory diagram illustrating the flow of data in the wireless communication monitoring system of the embodiment, and FIG. 9 is a flowchart illustrating operations of the wireless communication monitoring device 12.

The temperature detecting and transmitting device 11 is disposed so as to measure the temperature of a measurement target. The temperature detecting and transmitting device 11 measures the temperature of a measurement target by the temperature sensor 41, for example, every minute, adds temperature sensor ID and measurement time to the obtained temperature measurement data, and transmits the resultant data as wireless data from the transmitting unit 42.

In the wireless communication monitoring device 12, the communication unit 31 receives the wireless data from the temperature detecting and transmitting device 11 (S11) and determines whether or not the received wireless data is wireless data from the temperature detecting and transmitting device 11 as a monitoring target (S12).

When the received wireless data is wireless data from the temperature detecting and transmitting device 11 as a monitoring target in the determination of S12, the signal intensity detecting unit 32 detects the reception intensity of the wireless data. The signal intensity storing unit 33 obtains a communication margin in the wireless data from the reception intensity of the wireless data detected by the signal intensity detecting unit 32 and the lowest reception intensity set in the wireless communication monitoring device 12 (S13). The communication margin is the difference of the reception intensity of wireless data with respect to the lowest reception intensity. The obtained communication margin is stored together with present time indicated by the clock unit 38 into a storing device in the signal intensity storing unit 33 for each of the temperature detecting and transmitting devices 11 (S14).

Next, for example, each time the communication margin is calculated in the signal intensity storing unit 33 for each of the temperature detecting and transmitting devices 11, the signal intensity computing unit 34 obtains the average value of communication margins and the variation 6 in the communication margins in the period set in the setting unit 35. The signal intensity computing unit 34 obtains the ratio (average value/variation σ) of the average value to the variation σ as the computation value for determination (S15).

The determining unit 36 compares the computation value for determination (average value/variation σ) calculated by the signal intensity computing unit 34 with the threshold value set in the setting unit 35 (S16). When the computation value (average value/variation σ) for determination is equal to or larger than the threshold value as a result of the determination in S16 (S17), the process returns to S11 and the subsequent processes are repeated.

On the other hand, as a result of the determination in S16, when the computation value (average value/variation σ) for determination is less than the threshold value (S17) and it is set to output an alarm in the setting unit 35 (S18), the alarm output unit 37 outputs an alarm (S19).

After that, the wireless communication monitoring device 12 returns to S11 in the case of continuing the process or finishes the operation in the case of discontinuing the process (S20).

In the case where an alarm is output from the alarm output unit 37, in the temperature detecting and transmitting device 11 as an alarm target, the communication between the temperature detecting and transmitting device 11 and the wireless communication monitoring device 12 is in the unstable communication state. Consequently, the layout position of the corresponding temperature detecting and transmitting device 11 can be changed by the user so that the communication between the temperature detecting and transmitting device 11 and the wireless communication monitoring device 12 enters the stable communication state.

In the wireless communication monitoring device 12, an alarm is output from the alarm output unit 37 in the case where the communication between the temperature detecting and transmitting device 11 and the wireless communication monitoring device 12 is in the unstable communication state as described above. That is, in the communication between the temperature detecting and transmitting device 11 and the wireless communication monitoring device 12, an alarm is output, not after occurrence of a communication error, but in the case where the possibility of occurrence of a communication error is high. Therefore, by changing the layout position of the temperature detecting and transmitting device 11 as an alarm target by the user in accordance with an alarm output from the alarm output unit 37, occurrence of a communication error between the temperature detecting and transmitting device 11 and the wireless communication monitoring device 12 can be prevented.

In the wireless communication monitoring device 12, a threshold value for determining whether the communication state between the temperature detecting and transmitting device 11 and the wireless communication monitoring device 12 is an unstable communication state or a stable communication state, that is, a threshold value for determining whether an alarm output from the alarm output unit 37 is necessary or not is changed according to the time slots. For example, in the communication environment between the temperature detecting and transmitting device 11 and the wireless communication monitoring device 12, the threshold value in a time slot in which people often intervenes and an unstable communication state tends to be determined is set to be higher than that in a time slot in which a human hardly intervenes, so that the communication state is not easily determined as the unstable communication state. In such a manner, a situation such that an alarm is output frequently from the alarm output unit 37 due to an unpreventable circumstance can be prevented.

Next, a layout example of the temperature detecting and transmitting device 11 and the wireless communication monitoring device 12 in the wireless communication monitoring system and a correspondence example of the user who changes the layout position of the temperature detecting and transmitting device 11 in the case where an alarm is output from the alarm output unit 37 will be described with reference to FIGS. 10 to 12.

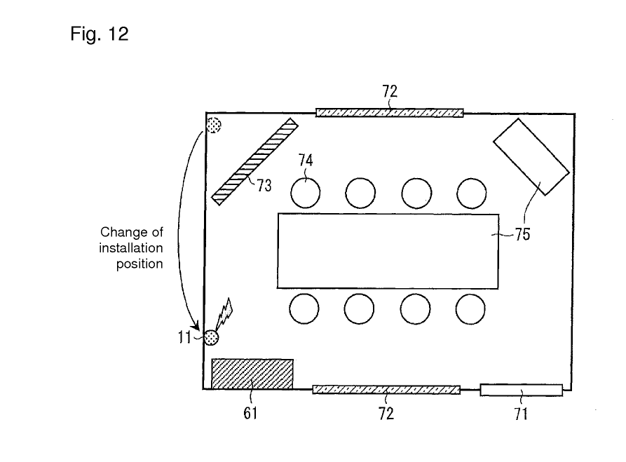

FIG. 10 is a schematic diagram illustrating a layout example of the temperature detecting and transmitting devices 11 and the wireless communication monitoring device 12 in a building, in the air-conditioning control system 1. FIG. 11 is a schematic diagram illustrating a structure of a room illustrated in FIG. 10 in which the temperature detecting and transmitting device 11 is disposed. FIG. 12 is a schematic diagram illustrating a state in which the layout position of the temperature detecting and transmitting device 11 is changed according to an alarm output from the alarm output unit 37 in the room shown in FIG. 11. In the example, the air-conditioning control system 1 monitors, for example, the temperature of a meeting room of a company and performs air-conditioning control to keep the room temperature optimum.

As illustrated in FIGS. 10 and 11, in each of rooms in a building, the air-conditioning devices 61 and the temperature detecting and transmitting devices 11 are disposed. Concretely, a table 75 and chairs 74 are disposed in the center of the room, a white board 73 for meetings and another table 75 are disposed around the table 75, and the temperature detecting and transmitting device 11 and the air-conditioning device 61 are disposed in corners of the room. Herein, 72 denotes windows and blinds, and 71 denotes a door. In a control room, the wireless communication monitoring device 12 and the air-conditioning control device 13 are disposed.

The temperature of the room of which temperature is adjusted by the air-conditioning device 61 is detected by the temperature detecting and transmitting device 11. The wireless communication monitoring device 12 collects temperature measurement data from the temperature detecting and transmitting devices 11 in the rooms and, based on the collected temperature measurement data, the wireless communication monitoring device 12 generates air-conditioning setting data for each of the rooms. The air-conditioning setting data is supplied to the air-conditioning control device 13, and the air-conditioning control device 13 controls the operation of the air-conditioning devices 61 in the rooms based on the input air-conditioning setting data.

The communication state between the temperature detecting and transmitting device 11 and the wireless communication monitoring device 12 is the stable communication state in the beginning of the installation of the air-conditioning control system 1. However, after that, the determining unit 36 in the wireless communication monitoring device 12 determines that the communication state of the temperature detecting and transmitting device 11 in any of the rooms and the wireless communication monitoring device 12 is the unstable communication state.

In a room such as a general meeting room as described above, the wireless communication environments are largely changed by factors such as movement of the tables 75 and the white board 73, opening/closing of the blinds, and movement of people. By the movement of a person such as changing of the posture, the communication environments are changed in seconds. That is, the movement of a person varies the communication intensity between the temperature detecting and transmitting device 11 and the wireless communication monitoring device 12. Once the white board 73 and the tables 75 are moved, they are not moved again in short time. Consequently, it does not vary the communication intensity but changes the communication intensity. Due to this, the value of the average value/variation σ of the communication margins changes and, in determination in the determining unit 36 of the wireless communication monitoring device 12, the stable communication state may change to the unstable communication state.

In the case where the determining unit 36 of the wireless communication monitoring device 12 determines that the communication state between the temperature detecting and transmitting device 11 in any of the rooms and the wireless communication monitoring device 12 is the unstable communication state, an alarm is output from the alarm output unit 37. When the user recognizes the alarm output, as illustrated in FIG. 12, the user changes the layout position of the temperature detecting and transmitting device 11 as an alarm target. In the case where an alarm is output again for the temperature detecting and transmitting device 11 as an alarm target whose layout position was changed, the layout position of the temperature detecting and transmitting device 11 is changed again. In such a manner, by maintaining the stable communication state between each of the temperature detecting and transmitting devices 11 and the wireless communication monitoring device 12, the wireless communication monitoring device 12 can prevent a dropout of temperature measurement data received from the temperature detecting and transmitting device 11.

The above embodiment has been described on assumption that the wireless communication monitoring device 12 collects temperature measurement data from the temperature detecting and transmitting device 11. However, the present invention is not limited to the above but can be applied to collection of various measurement data such as collection of power measurement data from, for example, a power detecting and transmitting device having a power sensor, disposed in a manufacture facility.

The wireless device 21, the clock unit 38, and the collecting device 22 (51) configuring the wireless communication monitoring device 12 illustrated in FIG. 2, and the signal intensity detecting unit 33, the signal intensity computing unit 34, the setting unit 35, the determining unit 36, and the alarm output unit 37 configuring the collecting device 22 (51) may be housed in one casing as the wireless communication monitoring device 12. Alternately, the blocks in proper combinations may be dispersedly housed as seemingly independent devices in a plurality of casings. By proper communication of the devices, the wireless communication monitoring device 12 may be configured.

For example, the functions of the four blocks of the signal intensity computing unit 34, the setting unit 35, the determining unit 36, and the alarm output unit 37 can be provided for a personal computer (hereinbelow, called a PC). In this case, the wireless communication monitoring device 12 is configured by the wireless device 21, and a device including the clock unit 38, and the signal intensity detecting unit 33 other than the PC, the signal intensity computing unit 34, the setting unit 35, the determining unit 36, and the alarm output unit 37.

Although the foregoing embodiment has been described that the wireless communication monitoring device 12 has the blocks illustrated in FIG. 2, the present invention is not limited to the configuration. For example, the wireless communication monitoring device 12 may have the blocks except for the alarm output unit 37 and outputs a determination result of the determining unit 36. In this case, the alarm output unit 37 exists as a device independent of the wireless communication monitoring device 12, receives a determination result from the determining unit 36 in the wireless communication monitoring device 12 and properly outputs an alarm.

In the foregoing embodiment, with respect to setting of a threshold value according to time slots in the setting unit 35, threshold values which vary according to the time slots in one day are set. However, the setting of the threshold value according to the time slots is not limited to the above but may be made according to days of the week (Saturday and Sunday) in a calendar or dates.

For example, in the case where the wireless communication monitoring system is installed in a building, in an environment in which a company is off on Saturdays and Sundays, it is preferable to set a threshold value in the case where people hardly intervenes as a threshold value on Saturdays and Sundays. In days when people hardly intervenes such as Golden Week holidays or summer holidays other than Saturdays and Sundays, it is preferable to set a threshold value in the case where people hardly intervenes like that on Saturdays and Sundays.

A configuration may be employed in which the wireless communication monitoring device 12 illustrated in FIGS. 1 and 2 has a display unit and proper information is displayed in the display unit.

Finally, the blocks of the wireless communication monitoring device 12, particularly, the blocks of the collecting device 22 may be configured by hardware logics or may be realized by software using a CPU as follows.

The wireless communication monitoring device 12 has a CPU (Central Processing Unit) for executing an instruction of a control program realizing functions, a ROM (Read Only Memory) storing the program, a RAM (Random Access Memory) developing the program, a storing device (storing medium) such as a memory for storing the program and various data, and the like. An object of the present invention can be achieved also by supplying a recording medium computer-readably recording program codes (an execute format program, an intermediate code program, and a source program) of a control program of the wireless communication monitoring device 12 as software realizing the above-described functions to the wireless communication monitoring device 12, and reading and executing the program codes recorded on the non-transitory computer-readable recording medium by the computer (or a CPU or an MPU).

As the recording medium, for example, any of tapes such as a magnetic tape and a cassette tape, disks including magnetic disks such as a floppy (registered trademark) disk and a hard disk, and optical disks such as a CD-ROM, an MO, an MD, a DVD, and a CD-R, cards such as an IC card (including a memory card) and an optical card, semiconductor memories such as a mask ROM, an EPROM, an EEPROM, and a flash ROM, and the like can be used.

The wireless communication monitoring device 12 is configured so that it can be connected to a communication network and the program codes may be supplied via the communication network. The communication network is not particularly limited. For example, the Internet, an intranet, an extranet, an LAN, an ISDN, a VAN, a CATV communication network, a virtual private network, a telephone line network, a mobile communication network, a satellite communication network, or the like can be used. A transmission medium as a component of a communication network is not particularly limited. For example, a wired medium such as IEEE1394, a USB, a power-line carrier, a cable TV line, a telephone line, or an ADSL line or a wireless medium such as an infrared ray of an IrDA or a remote controller, Bluetooth (registered trademark), 802.11 wireless line, an HDR, a cellular phone network, a satellite line, or a digital terrestrial network can be used. The present invention can be also realized in a form in which the program codes are embodied by electronic transmission and a computer data signal is embedded in a carrier wave.

With the configuration of the present invention, in the case where the reception state of a wireless signal from the detecting and transmitting device is the unstable communication state, the user can know the situation and predict the possibility of occurrence of a dropout of reception data. Consequently, the user can prevent occurrence of a dropout of reception data by changing the layout position of the detecting and transmitting device and setting the reception state of the wireless signal from the detecting and transmitting device to the stable communication state.

The present invention is not limited to the foregoing embodiment but can be variously changed within the scope of the claims. An embodiment obtained by properly combining technical means disclosed in the embodiment is also included in the technical scope of the present invention.

### INDUSTRIAL APPLICABILITY

The present invention can be used for various systems such as an air-conditioning control system controlling the temperature of a room, a power control system controlling the power consumption amount of a manufacture facility, a system collecting measurement data from a sensor by wireless communication and controlling operation of a control target.

1. A wireless communication monitoring device comprising:
a receiving unit configured to receive wireless signals from a detecting and transmitting device, the detecting and transmitting device being configured to perform measurement by a sensor and sequentially transmitting obtained measurement data as wireless signals;
a signal intensity detecting unit configured to detect reception intensities of the wireless signals sequentially received by the receiving unit;
a signal intensity storing unit configured to compare each of the reception intensities detected by the signal intensity detecting unit with a predetermined minimum reception intensity to obtain a communication margin indicative of a margin of each reception intensity with respect to the minimum reception intensity, and to sequentially store the obtained communication margins into a storing device;
a signal intensity computing unit configured to obtain an average value and a variation of communication margins stored in the storing device and to compute a ratio of the average value to the variation of communication margins as a computation value for determination; and
a determining unit configured to determine whether a reception state of the wireless signal in the receiving unit is an unstable communication state or a stable communication state by comparing the computation value for determination with a predetermined threshold value.

2. The wireless communication monitoring device according to claim 1, wherein a value of the computation value for determination, when reception success rate of the wireless signal is equal to or larger than a predetermined value based on results of a plurality of times of reception of the wireless signal in the receiving unit, is set as the threshold value for use by the determining unit.

3. The wireless communication monitoring device according to claim 1, wherein the threshold value used by the determining unit is changed according to a time slot.

4. The wireless communication monitoring device according to claim 1, comprising an alarm output unit configured to output an alarm in the case where the unstable communication state is determined by the determining unit.

5. A wireless communication monitoring system comprising:
the wireless communication monitoring device according to claim 4 and a detecting and transmitting device,
wherein the detecting and transmitting device has a sensor configured to perform measurement and a transmitting unit configured to sequentially transmit measurement data obtained from the sensor as wireless signals.

6. A wireless communication monitoring method comprising:
a receiving step of receiving wireless signals from a detecting and transmitting device configured to perform measurement by a sensor and to sequentially transmit obtained measurement data as wireless signals;
a signal intensity detecting step of detecting reception intensities of the wireless signals sequentially received in the receiving step;
a signal intensity storing step of comparing each of the reception intensities detected in the signal intensity detecting step with predetermined minimum reception intensity to obtain a communication margin indicative of a margin of each reception intensity with respect to the minimum reception intensity, and sequentially storing the obtained communication margins into a storing device;
a signal intensity computing step of obtaining an average value and a variation of communication margins stored in the storing device and computing a ratio of the average value to the variation of the communication margins as a computation value for determination; and
a determining step of determining whether a reception state of the wireless signal in the receiving step is an unstable communication state or a stable communication state by comparing the computation value for determination with a predetermined threshold value.

7. A wireless communication monitoring device comprising:
a receiving unit configured to sequentially receive wireless signals from a transmitting device;
a signal intensity detecting unit configured to detect reception intensities of the wireless signals sequentially received by the receiving unit;
a signal intensity storing unit configured to compare each of the reception intensities detected by the signal intensity detecting unit with predetermined minimum reception intensity to obtain a communication margin indicative of a margin of each reception intensity with respect to the minimum reception intensity, and to sequentially store the obtained communication margins into a storing device;
a signal intensity computing unit configured to obtain an average value and a variation of communication margins stored in the storing device and to compute a ratio of the average value to the variation of communication margins as a computation value for determination; and
a determining unit configured to determine whether a reception state of the wireless signal in the receiving unit is an unstable communication state or a stable communication state by comparing the computation value for determination with a predetermined threshold value.

8. (canceled)

9. A computer-readable recording medium having stored thereon, a control program including instructions which when executed on a computer, causes the computer to function as each of the units in the wireless communication monitoring device according to claim 1.

10. The wireless communication monitoring device according to claim 2, wherein the threshold value used by the determining unit is changed according to a time slot.

11. The wireless communication monitoring device according to claim 2, comprising an alarm output unit outputting an alarm in the case where the unstable communication state is determined by the determining unit.

12. The wireless communication monitoring device according to claim 3, comprising an alarm output unit outputting an alarm in the case where the unstable communication state is determined by the determining unit.

13. A computer-readable recording medium having stored thereon, a control program including instructions which when executed on a computer, causes the computer to function as each of the units in the wireless communication monitoring device according to claim 2.

14. A computer-readable recording medium having stored thereon, a control program including instructions which when executed on a computer, causes the computer to function as each of the units in the wireless communication monitoring device according to claim 3.

15. A computer-readable recording medium having stored thereon, a control program including instructions which when executed on a computer, causes the computer to function as each of the units in the wireless communication monitoring device according to according to claim 4.

16. A computer-readable recording medium having stored thereon, a control program including instructions which when executed on a computer, causes the computer to function as each of the units in the wireless communication monitoring device according to claim 7.
